(19) United States
(12) Patent Application Publication
(10) Pub. No.: US 2024/0044031 A1
(43) Pub. Date: Feb. 8, 2024

(54) ADDITIVE MANUFACTURING OF POLYMERIC MATERIAL WITH METALLIC STRUCTURES

(71) Applicants: Tengteng Tang, Tempe, AZ (US); Xiangjia Li, Chandler, AZ (US)

(72) Inventors: Tengteng Tang, Tempe, AZ (US); Xiangjia Li, Chandler, AZ (US)

(21) Appl. No.: 18/358,725

(22) Filed: Jul. 25, 2023

Related U.S. Application Data
(60) Provisional application No. 63/392,360, filed on Jul. 26, 2022.

(51) Int. Cl. C25D 1/00; B33Y 10/00; B33Y 30/00

(52) U.S. Cl. CPC C25D 1/003; B33Y 10/00; B33Y 30/00

(57) ABSTRACT

Apparatuses, systems, and methods for electrical field-assisted heterogeneous material printing (EF-HMP) of metal-polymer composite structure include a printing platform, a solution tank, an optical projection system, and an electrical field generation and control module. An additive manufacturing method for a metal-polymer composite structure includes preparing a photocurable electrolyte solution by mixing a photocurable liquid resin with a conductive nanofiller, a metal salt solution, a photo initiator, and deionized water. The method further includes initiating photopolymerization of the photocurable liquid resin to form a photocured polymer matrix by directing a projection of ultraviolet light energy from a light source onto the photocurable electrolyte solution. The method further includes depositing a metal structure onto the photocured polymer matrix. In this manner, both the photopolymerization and the metal electrodeposition are performed using the same photocurable electrolyte solution.

### CROSS REFERENCE TO RELATED APPLICATIONS

This application claims priority to, and the benefit of, U.S. Provisional Patent Application Ser. No. 63/392,360 entitled “ADDITIVE MANUFACTURING OF POLYMERIC MATERIAL WITH METALLIC STRUCTURES” filed on Jul. 26, 2022. The '360 Application is hereby incorporated by reference in its entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates generally to additive manufacturing, and more specifically to digital mask-image projection-based and electrodeposition-based additive manufacturing.

### BACKGROUND

Natural organisms have evolved complex hierarchical architectures with highly integrated materials, structures, and functions over millions of years of evolution, and provide guidance for designing high-performance functional devices. Additive manufacturing (AM) breaks through the barriers of traditional manufacturing methods and makes bionic manufacturing possible. For example, a scaly-foot snail that lives in deep-sea hydrothermal vents has attracted the attention of scientists because of its metallic outer surface. The outer layer of its shell is mainly composed of the iron sulfide-based layer containing greigite, Fe₃S₄ with a thickness of about 30 μm. This substance is not known to exist in the skeleton of any other species, and gives the snail's shell qualities such as extreme hardness and excellent high-temperature resistance. Due to these extraordinary properties, heterogeneous material systems based on metallic structures and polymer matrixes have become a promising field of research because of their potential applications in protecting, energy dispersion, sensing, and microelectron-mechanical systems.

Benefitting from different three-dimensional (3D) printing technologies and widely available printing materials, AM has expanded its usefulness from simple prototype verification to mass production of highly functional devices. Stereolithography (SL) is one of the most widely used AM technologies for fabricating multi-material and multi-scale structures. An alternative to extrusion-based printing technologies, such as FDM (fused deposition modeling) or DIW (direct ink writing), the SL process involves a photosensitive liquid resin that is made solid after being irradiated by a certain wavelength of light, and the resin is cured to obtain a structure.

However, it is particularly challenging to use SL to simultaneously print metallic materials with a polymer matrix. Rather, conventional manufacturing approaches involve multiple steps. Moreover, conventional manufacturing approaches are complicated, time-consuming, and limited to certain types of materials. Moreover, conventional manufacturing approaches result in metal plated layers that do not firmly adhere to the surface on which the metal layer is deposited, which increases problems associated with hardenability, non-uniform microstructures, and cracking. Accordingly, improved approaches are desirable.

### SUMMARY

In an exemplary embodiment, an additive manufacturing method for a metal-polymer composite structure includes preparing a photocurable electrolyte solution by mixing a photocurable liquid resin with a conductive nanofiller, a metal salt solution, a photo initiator, and deionized water, initiating photopolymerization of the photocurable liquid resin to form a photocured polymer matrix by directing a projection of ultraviolet light energy from a light source onto the photocurable electrolyte solution, and depositing a metal structure onto the photocured polymer matrix.

In various embodiments, the photopolymerization includes crosslinking of a polymer chain. In various embodiments, the photopolymerization further comprises enclosing the metal salt and conductive nanofillers during crosslinking.

In various embodiments, the photopolymerization further includes switching off the light source, raising a printing platform by a first predetermined distance, moving uncured photocurable electrolyte solution to between the printing platform and an interior surface of a solution tank, lowering the printing platform by a second predetermined distance, moving a first portion of the uncured photocurable electrolyte solution from between the printing platform and the interior surface of the solution tank, switching on the light source, and solidifying (e.g., curing) a second portion of the uncured photocurable electrolyte solution that remains between the printing platform and the interior surface of the solution tank. These steps can be repeated to form a plurality of polymer layers until a desired thickness of the photocured polymer matrix is achieved.

In various embodiments, the preparing, initiating, and depositing occur at room temperature. In various embodiments, the depositing includes switching off the light source and activating an electrical field. In various embodiments, the activating further includes generating metal ions that move to a surface of the photocured polymer matrix, wherein the metal ions form metal particles along the surface of the photocured polymer matrix. In various embodiments, the depositing further includes moving the photocured polymer matrix from a first position wherein the photocured polymer matrix is at least partially submerged in the photocurable electrolyte solution to a second position wherein only a portion of the photocured polymer matrix is in contact with the photocurable electrolyte solution.

In various embodiments, the electric field is generated using at least one anode located in the photocurable electrolyte solution. In various embodiments, the photocured polymer matrix acts as a cathode to generate the electric field.

In various embodiments, the photocured polymer matrix includes a plurality of semicircular microstructures, and the metal structure is deposited over the plurality of semicircular microstructures.

In an exemplary embodiment, an additive manufacturing system for printing a metal-polymer composite structure includes a solution tank configured to contain a photocurable electrolyte solution and having a refractive surface, a printing platform moveable with respect to the solution tank, a light source configured to project a light energy through the refractive surface and into the photocurable electrolyte solution, a cathode mounted to the printing platform, and an anode configured to be located in the solution tank.

In various embodiments, the additive manufacturing system further comprises a film disposed on the refractive surface, the film including at least one of a polydimethylsiloxane or a polytetrafluoroethylene. In various embodiments, the additive manufacturing system further comprises a power source configured to generate an electric field through the photocurable electrolyte solution using the cathode and the anode.

In various embodiments, the additive manufacturing system further comprises a control unit in electronic communication with the power source. In various embodiments, the light energy is an ultraviolet light. In various embodiments, the light source is a digital micromirror device projector. In various embodiments, the additive manufacturing system further comprises the photocurable electrolyte solution including a photocurable liquid resin, a conductive nanofiller, a metal salt solution, a photo initiator, and deionized water.

In various embodiments, the photocurable electrolyte solution includes between 30 wt % and 35 wt % of the photocurable resin, between 1 wt % and 3 wt % of the photo initiator, between 1 wt % and 3 wt % of the conductive nanofiller, between 30 wt % and 40 wt % of the metal salt solution, and a remainder wt % of deionized water.

In an exemplary embodiment, an additive manufacturing method for controlling deposition of a metallic structure onto a polymer matrix includes turning on a light source to project a light energy into a photocurable electrolyte solution, forming a photocured polymer matrix with the light energy and the photocurable electrolyte solution, moving a printing platform away from the light source a predetermined distance, determining whether a material index is equal to an identifier of a layer onto which a metal is to be deposited, in response to the material index being equal to the identifier, connecting a power source to a cathode and an anode to generate an electric field through the photocurable electrolyte solution, and depositing a metal onto a surface of the photocured polymer matrix that is in contact with the photocurable electrolyte solution.

In various embodiments, the additive manufacturing method further comprises slicing a digital model to generate a series of mask images, storing a material index of each layer of the photocured polymer matrix in memory, wherein a layer onto which the metal is to be deposited is marked with the identifier, loading the series of mask images to a printing operation software to form a light beam with a desired 2D pattern using the light energy, and moving the printing platform to an initial position.

In various embodiments, the additive manufacturing method further comprises raising the printing platform by a first predetermined distance, and lowering the printing platform by second predetermined distance, less than the first predetermined distance, so that a new layer of material is formed under pressure.

An additive manufacturing method for a metal-polymer composite structure may comprise preparing a photocurable electrolyte solution, wherein the preparing step may comprise mixing a photocurable liquid resin with a conductive nanofiller, a metal salt solution, a photo initiator, and deionized water. The method may further comprise initiating photopolymerization of the photocurable liquid resin to form a photocured polymer matrix by directing a projection of ultraviolet light energy from a light source onto the photocurable electrolyte solution. This photopolymerization may comprise crosslinking a polymer chain and enclosing the metal salts and conductive nanofillers, forming a solid polymer layer from the resin under UV light exposure.

The method may further comprise depositing a metal structure onto the photocurable electrolyte solution. The depositing may comprise switching off the light source and activating an electrical field. Activation of the electrical field may cause metal ions to move to a surface of the photocured polymer matrix, forming a coarse grain layer of metal particles that attach to the surface of the smooth polymer matrix surface.

This process may be called Electrical Field-Assisted Heterogenous Material Printing (EF-HMP) since the electrical field controls the flow of metal ion deposition onto the solid polymer matrix layer. The photocurable resin electrolyte solution mixture may act as an electrolyte to maintain metal ion transport and promote metal deposition onto the polymer matrix. The conductive nanofillers in the solution enhance the photocurable resin's conductivity, while the metal salt solution acts as the metal ion source. Accordingly, deposition of metallic structures is determined by metal ion concentration, electrical field voltage, and deposition time. This method further enables fabrication of metallic structures in a single step at room temperature.

The contents of this summary section are intended as a simplified introduction to the disclosure and are not intended to limit the scope of any claim.

### BRIEF DESCRIPTION OF THE DRAWINGS

With reference to the following description, appended claims, and accompanying drawings:

FIG. 1A and FIG. 1B illustrate diagrams of Electrical Field-Assisted metal deposition in accordance with various exemplary embodiments;

FIG. 2A and FIG. 2B illustrate an example process plan for Electrical Field-Assisted Heterogenous Material Printing (EF-HMP) as well as diagrams of the fabrication process in accordance with various exemplary embodiment;

FIG. 3 illustrates diagrams of metal-polymer composite structures printed using the EF-HMP process and having different microstructures (e.g., linear, square, trapezoidal, semicircular) and having different metal layer thicknesses, in accordance with various exemplary embodiments;

FIG. 4 illustrates diagrams of the metal-polymer composite structures of FIG. 3 with a simulated electric potential overlaying the metal-polymer composite structures, in accordance with various exemplary embodiments;

FIG. 5 illustrates diagrams of metal-polymer composite structures printed using the EF-HMP process, and having different rectangular microstructures and different metal layer thicknesses, with a simulated von Mises stress overlaying the metal-polymer composite structures in accordance with various exemplary embodiments;

FIG. 6 illustrates diagrams of metal-polymer composite structures printed using the EF-HMP process, and having different trapezoidal microstructures and different metal layer thicknesses, with a simulated von Mises stress overlaying the metal-polymer composite structures in accordance with various exemplary embodiments;

FIG. 7 illustrates diagrams of metal-polymer composite structures printed using the EF-HMP process, and having different semicircular microstructures and different metal layer thicknesses, with a simulated von Mises stress overlaying the metal-polymer composite structures in accordance with various exemplary embodiments;

FIG. 8 illustrates CAD models of a photocured polymer structures with rectangular, trapezium, and semicircular microstructures, a slicing software, and projection mask images, in accordance with various exemplary embodiments;

FIG. 9 illustrates a 3D printed thin film with copper coating, a plating thickness after 5 minutes versus voltage, and a plating thickness at 80V versus time, in accordance with various exemplary embodiments;

FIG. 10 illustrates a simulation of metal deposition under the electric field of various shaped rectangular microstructures at different deposition time durations, in accordance with various exemplary embodiments;

FIG. 11 illustrates a simulation of metal deposition under the electric field of various shaped semicircular microstructures at different deposition time durations, in accordance with various exemplary embodiments;

FIG. 12 illustrates a simulation of metal deposition under the electric field of various shaped trapezium microstructures at different deposition time durations, in accordance with various exemplary embodiments;

FIG. 13 illustrates a top view of a rectangular microstructure after deposition using (a) energy dispersive X-ray spectroscopy and (b) scanning electron microscopy, in accordance with various exemplary embodiments;

FIG. 14 illustrates a top view of a trapezoidal microstructure after deposition using (a) energy dispersive X-ray spectroscopy and (b) scanning electron microscopy, in accordance with various exemplary embodiments; and

FIG. 15 illustrates a top view of a semi-circular microstructure after deposition using (a) energy dispersive X-ray spectroscopy and (b) scanning electron microscopy, in accordance with various exemplary embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of principles of the present disclosure.

Apparatus, systems, and methods of the present disclosure include electrical field-assisted heterogeneous material printing where both stereolithography and electrodeposition are combined into a single stage process using a photocurable electrolyte solution. Moreover, apparatus, systems, and methods of the present disclosure enable the performance of the stereolithography and electrodeposition processes at room temperature, thereby simplifying the process. A stereolithography process of the present disclosure is suitable to produce microscale complex 3D structures and is characterized by high resolution, cross-scale processing, high processing efficiency, and low processing costs.

Systems, apparatuses, and methods of the present disclosure provide for additive manufacturing of metal-polymer composite structures in a single step at room temperature. Systems, apparatuses, and methods of the present disclosure include a polymer matrix-based composite that can act as an electrolyte so as to maintain the metallic ions transport and promote metal deposition on a photocured polymer matrix. To increase the electrical conductivity of a photocurable resin, the present disclosure includes, in an exemplary embodiment, a photocurable electrolyte solution including poly(3,4-ethylenedioxythiophene)-poly(styrenesulfonate) (PEDOT:PSS) mixed with poly(ethylene glycol) diacrylate (Mn 700) (PEGDA). Inorganic compounds can be added to the photocurable electrolyte solution to provide enough metal ions for the deposition. A mask image projection-based stereolithography (MIP-SL) process is first performed on the photocurable electrolyte solution to form a photocured polymer structure. Exposure time, curing depth, viscosity, and resistivity are all parameters that can be adjusted and/or optimized during the MIP-SL process to achieve the desired part. After MIP-SL, an electrical field generation module is provided and integrated with MIP-SL for the metal deposition. The metallic structures can grow on the cured polymer matrix during the printing process by controlling the electrical field. The deposition of metallic structures is determined, at least in part, by the metal ion concentration, electrical field voltage, and deposition time. In order to achieve accurate printing of polymer/metal material systems with desired geometric shapes, the process parameters of the present disclosure have been optimized based on physics-based modeling, simulation, and testing. The relation between geometric morphology, material properties, and printing process parameters was identified to establish a route to build the desired heterogeneous materials system with complex 3D shapes. The printing results demonstrate that the disclosed systems, apparatuses, and methods provide a novel manufacturing tool for heterogeneous materials fabrication, which show enormous potential in fabricating devices for various applications, such as flexible sensors, energy harvesting, healthcare, and robotics.

Systems, methods, and apparatuses of the present disclosure selectively print polymer and metal structures at room temperature by controlling a light source and an electric field. Specifically, when the light source is turned on and the electric field is turned off, photocurable electrolyte solution is solidified after ultraviolet light exposure. The chain-growth photopolymerization of photocurable resin is initiated by absorption of ultraviolet light, and conductive nanofillers and metal salts are enclosed during the crosslinking of the polymer chain. In terms of metal fabrication, the preprinted polymer part is lifted until only the surface where the metal is desired to be printed contacts with the photocurable electrolyte solution. The light source is turned off, and the electric field is turned on. When a copper electrode is used, copper particles gradually form on the surface of the preprinted polymer part until the electrical field is turned off. During the metal printing process, the copper plate at the anode loses two electrons under oxidation and becomes copper cations Cu²⁺, which dissolve in the polymer-based electrolyte solution. The copper cations in the photocurable electrolyte solution are reduced to metallic copper particles at the cathode by gaining two electrons and accumulating on the surface of the preprinted part. By accumulating the polymer and metal layer by layer, the 3D shape can be formed. Hence, systems, methods, and apparatuses of the present disclosure enable the metal and polymer fabrication in a single process with a photocurable conductive solution at room temperature by controlling the electrical field and light exposure. In this manner, tedious multiple manufacturing processes are effectively avoided.

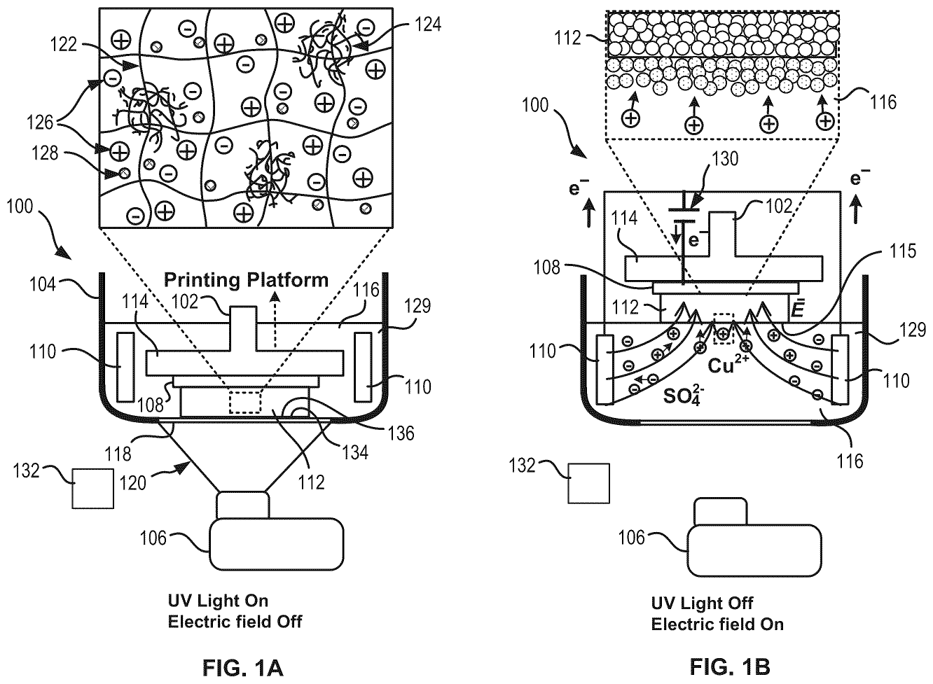

With reference to FIG. 1A and FIG. 1B, an apparatus 100 for electrical field-assisted heterogeneous material printing (EF-HMP) is illustrated, in accordance with various embodiments. Apparatus 100 generally includes a printing platform 102 moveable with respect to a solution tank 104, an optical projection system including a light source 106, and an electrical field generation and control module including a cathode 108 and at least one anode 110. FIG. 1A depicts the apparatus 100 during a stereolithography process whereby a photocured polymer structure is additively manufactured using mask image projection-based stereolithography (MIP-SL). FIG. 1B depicts the apparatus 100 during an electrodeposition process whereby a layer of metal is deposited over a surface of the photocured polymer structure 112. As depicted, the apparatus 100 is designed to integrate the MIP-SL process and the electrodeposition process into a single stage process (i.e., both the MIP-SL process and the electrodeposition process are performed by the apparatus 100) without having to move the part between different apparatuses.

Printing platform 102 can have a body 114 and the cathode 108 mounted to the body 114 of the printing platform 102. The cathode 108 can be made of a conductive metal or metal alloy (e.g., copper, brass, iron, stainless steel, zinc, nickel, cadmium, silver, gold tin, rhodium, etc.). Printing platform 102 can be moveable along a z-axis with respect to the solution tank 104. In this regard, the printing platform 102 can include a linear motion module, such as a ball screw, a belt-driven and/or a lead screw linear motion system, or the like). The solution tank 104 can be any suitable container for containing a photocurable electrolyte solution 116. In various embodiments, the solution tank 104 is a glass container (e.g., a glass tank).

The solution tank 104 includes a refractive surface 118 configured to refract a light energy 120 (e.g., a beam of light) received from the light source 106. Refractive surface 118 can be a transparent surface. A curing depth of the photocurable electrolyte solution 116 can be a function of a refractive index of the refractive surface 118. The light source 106 can be positioned and configured to project the light energy 120 through the refractive surface 118 and into the photocurable electrolyte solution 116. In various embodiments, one or more mirrors or lenses can be disposed between the light source 106 and the refractive surface 118 for positioning and/or focusing the light energy 120. The light energy 120 can be an ultraviolet light. Accordingly, the light source 106 can be an ultraviolet light source. The light source 106 can include a digital micromirror device including an array of adjustable micromirrors configured to control a brightness of the light energy 120 at a pixel level. The light source 106 can be a digital micromirror device projector, in accordance with various embodiments.

The photocurable electrolyte solution 116 can include a photocurable resin 122 such as poly(ethylene glycol) diacrylate (PEGDA). The photocurable resin 122 can be a PEGDA having an average molecular weight of 700 (i.e., PEDGDA Mn 700). The photocurable resin 122 can initially be a liquid resin. The photocurable resin 122 can be solidified to form a two-dimensional (2D) pattern under a light beam projected from the light source 106 (see FIG. 1A). In this manner, the 2D pattern can be sequentially varied such that each layer of the photocured polymer structure 112 can be a different shape.

The photocurable electrolyte solution 116 can further include conductive additives or nanofillers 124 such as carbon nanotubes, silver nanowires, or poly(3,4-ethylenedioxythiophene)-poly (styrene sulfonate) (PEDOT:PSS). PEDOT:PSS is composed of two ionomers, one of which is sulfonated polystyrene and the other is a conjugated polymer based on polythiophene, known as poly(3,4-ethylene dioxythiophene) (PEDOT). These charged macromolecules form a macromolecular salt and provide conductivity to the material, even after printing. PEDOT:PSS has the highest efficiency among conductive organic materials, making it suitable for flexible and biodegradable electrical circuits. Accordingly, the conductive nanofillers 124 can improve the conductivity of the photocurable resin. The conductive nanofillers 124 can be PEDOT:PSS in pure pellet form with 3.0-4.0% H2O.

The photocurable electrolyte solution 116 can further include a salt of the metal being deposited (a metal salt solution 126). For example, where copper is being deposited, the photocurable electrolyte solution 116 can further include a copper sulfate (CuSO₄) solution. For example, the photocurable electrolyte solution 116 can include a 1 mol/L Copper (II) sulfate (CuSO₄) solution. The photocurable electrolyte solution 116 can be formed by adding CuSO₄ in crystal form. However, other metal salt solutions can be used depending on the desired composition of the photocured polymer structure 112.

The photocurable electrolyte solution 116 can further include a photo initiator 128 such as phenyl bis(2,4,6-trimethyl benzoyl) phosphine oxide (such as that available commercially from CIBA as a solid under the trade name “IRGACURE 819”). Photo initiators 128 can be molecules that absorb photons upon irradiation with light and form reactive species out of the excited state, which initiate consecutive reactions. Stated differently, the photo initiators 128 can be added to enhance conversion of absorbed light energy, ultraviolet or visible light, into chemical energy in the form of initiating species. Accordingly, the addition of photo initiators 128 in the photocurable electrolyte solution 116 can initiate the photopolymerization of the photocurable resin 122 in the presence of the light energy 120.

The photocurable electrolyte solution 116 can further include deionized water 129.

The photocurable electrolyte solution 116 can be added to the solution tank 104 and the photocurable electrolyte solution 116 can be in contact with the refractive surface 118. The photocurable electrolyte solution 116 can be disposed opposite the refractive surface 118 from the light source 106. The photocurable electrolyte solution 116 can include a photocurable resin. In response to the light source 106 being turned on, the photocurable electrolyte solution 116 can be solidified after exposure to the light energy 120. Exposure to the light energy 120 initiates a chain-growth photopolymerization of the photocurable electrolyte solution 116 by absorption of light energy 120. The conductive nanofillers in the photocurable electrolyte solution 116 can be enclosed during the crosslinking of the polymer chain. The metal salts (e.g., copper sulfate) in the photocurable electrolyte solution 116 can be enclosed during the crosslinking of the polymer chain. Upon being exposed to the light energy 120, the photocurable electrolyte solution 116 solidifies into the photocured polymer structure 112. Initially, the cathode 108 is lowered in closed proximity to the refractive surface 118 so that the photocured polymer structure 112 attaches to the cathode 108. In this regard, the cathode 108 can be placed at least within a distance equal to a layer thickness of the photocured polymer structure 112. The layer thickness can be approximately 0.2 mm; though the layer thickness can vary depending on the exposure time of the light energy 120, among other factors. The MIP-SL exposure time for each layer can be between 5 minutes and 20 minutes in various embodiments, between 10 minutes and 14 minutes in various embodiments, or about 12 minutes, wherein the term “about” in this regard can only mean ±1 minute. In the initial position, the cathode 108 can be placed in contact with an interior surface 134 (also referred to herein as an upper surface) of the solution tank 104. Once an initial layer is formed on the cathode 108, the printing platform 102 is moved away from the refractive surface 118 and a new layer is formed thereon. By accumulating the polymer layer by layer, the photocured polymer structure 112 can be formed into a three-dimensional (3D) shape at room temperature.

In various embodiments, the photocurable electrolyte solution 116 can be prepared by mixing 45 wt % of the photocurable resin 122 (e.g., PEGDA) with 2 wt % of the photo initiator 128 (e.g., phenyl bis(2,4,6-trimethyl benzoyl) phosphine oxide). The nanofillers 124 (e.g., pellet formed PEDOT:PSS) can be dissolved in the metal salt solution 126 (e.g., a remaining proportion of 1 mol/L CuSO₄ solution) by stirring at room temperature (25° C.). For example, the nanofillers 124 can be stirred at 200 rpm for 0.5 hours at room temperature. In various embodiments, the percentage by weight of the nanofillers 124 is between 1 wt % and 3 wt % (e.g., 1 wt %, 1.5 wt %, 2 wt %, 2.5 wt %, or 3 wt %). The nanofiller 124/metal salt solution 126 mixture can be added to the photocurable resin 122/photo initiator 128 mixture and stirred at a predetermined rotational speed for a predetermined stirring duration (e.g., 200 rpm for 1.5 hours at room temperature). In various embodiments, the prepared photocurable electrolyte solution 116 can be degassed using a vacuum chamber to remove air bubbles in preparation for the material printing process. In various embodiments, a composition of the photocurable electrolyte solution 116 used for printing and electrodeposition is 32.5 wt % of PEGDA, 2 wt % of IRGACURE 819 photo initiator, 2 wt % PEDOT:PSS, 35 wt % of 1 mol/L CuSO₄ solution, and 28.5 wt % of deionized water. In various embodiments, a composition of the photocurable electrolyte solution 116 used for printing and electrodeposition is between 30 wt % and 35 wt % of photocurable resin 122, between 1 wt % and 3 wt % of photo initiator 128, between 1 wt % and 3 wt % of nanofillers 124, between 30 wt % and 40 wt % of metal salt solution 126, and the remainder wt % of deionized water. The deionized water can be added when mixing photocurable PEGDA matrix and conductive PEDOT:PSS fillers.

The nanofillers 124 can be evenly distributed in the photocurable resin 122. The curing depth of the photocurable electrolyte solution 116 can be determined by the light penetration depth and light exposure energy. The concentration of the nanofillers 124 can directly influence the curing parameter since the nanofiller 124 particles scatter the projected light and further hinder the photopolymerization process. The characterization of the photocurable electrolyte solution 116 gives an intuitive insight to choose the suitable concentration of nanofillers 124 for printing. The viscosity of the photocurable electrolyte solution 116 increases with the increase of concentration of nanofillers 124. The viscosity of the photocurable electrolyte solution 116 increased above a threshold refill viscosity (e.g., 1,000 Pascal-second (Pa s) when the concentration of nanofillers 124 was increased to 3 wt %. If the viscosity of the photocurable electrolyte solution 116 is greater than the threshold refill viscosity, the material is hard to refill back to the fabrication area for the next polymeric layer by only using atmosphere pressure and the material gravity and tends to require extra tools to achieve the material refilling. Moreover, the photocurable electrolyte solution 116 becomes unsuitable for EF-HMP printing because the low fluidity and high viscosity resistance make the copper cations Cu²⁺ challenging to transport. Accordingly, different concentrations of nanofillers 124 were tested and screened out a suitable concentration for printing, as it is desirable for the photocurable electrolyte solution 116 to be suitable not only for curing but also for the electrical assisted deposition.

In various embodiments, the curing depth of the photocurable electrolyte solution 116 decreases gradually as the concentration of nanofillers 124 increases, which is caused by the light-shielding properties of the increasingly aggregated nanofillers 124 (e.g., PEDOT:PSS). For example, during testing, the cure depth of the photocurable electrolyte solution 116 decreased from 320 μm to 140 μm when the concentration of nanofillers 124 was increased to 10 wt %. The curing depth of the photocurable electrolyte solution 116 after adding the nanofillers 124 can be determined using the following equation:

$${C}_{d} = ( \frac{{η}_{0}}{{η}_{p} - {η}_{0}} ) \frac{{λ}^{2}}{d} ln ( \frac{t}{{t}_{c}} ) \frac{1}{φ} \qquad Eq . 1$$

where η₀ is the refractive index of the photocurable resin 122, ηₚ is the refractive index of the nanofillers 124, λ is the wavelength of light in nm, d is diameter of the nanofiller 124 particles, t is the exposure time, t_{c} is the critical exposure time, and p is the concentration of nanofiller 124 particles.

In various embodiments, during testing, when the concentration of PEDOT:PSS nanofillers 124 exceeded 5 wt %, the curing depth of the photocurable electrolyte solution 116 was reduced but not as drastically as when the nanofillers 124 increased from 1 wt % to 5 wt %. In contrast, the viscosity of the photocurable electrolyte solution 116 increased sharply. This is because 2 wt % of the PEDOT:PSS nanofillers 124 can homogeneously suspend inside the PEGDA based photocurable electrolyte solution 116, and the photocurable electrolyte solution 116 had flowability. While the photocurable electrolyte solution 116 behaved like a slurry when the concentration of PEDOT:PSS nanofillers 124 increased to 10 wt %. Since the viscosity of PEDOT:PSS based photocurable electrolyte solution 116 with a proportion larger than 3 wt % had far exceeded the threshold refill viscosity, it was not easy to fabricate the metal layer by using the disclosed EF-HMP process. Rather, it is preferred, in various embodiments, that a photocurable electrolyte solution 116 with a ratio of PEDOT:PSS nanofillers 124 less than 3% be selected as the printing material. The exposure time of the photocurable electrolyte solution 116 increased with an increase in the concentration of PEDOT:PSS nanofillers 124. However, the exposure time increased only slightly as the concentration of PEDOT:PSS nanofillers 124 increased from 1 wt % to 3 wt %; whereas, once the concentration of PEDOT:PSS nanofillers 124 exceeded the threshold of 5 wt %, the curing time of the photocurable electrolyte solution 116 increased drastically. For example, the exposure time required about 45 seconds to solidify the printing electrolyte solution with 3 wt % PEDOT:PSS nanofillers 124 while it takes nearly 8 times longer (about 350 s) to cure the 5 wt % PEDOT:PSS solution. This is because when the concentration of PEDOT:PSS nanofillers 124 was larger than 3 wt % the PEDOT:PSS aggregated into large particles, which absorbed and scattered most of light.

With particular focus on FIG. 1B, a metal layer 115 can be deposited onto a surface of the photocured polymer structure 112 using the apparatus 100. The light source 106 can be turned off and the photocured polymer structure 112 can be lifted or moved (e.g., in the positive z-direction) until only the surface where the metal is desired to be printed contacts with the photocurable electrolyte solution 116. The cathode 108 and the one or more anodes 110 (two anodes 110 are illustrated, each at opposite sides of the photocured polymer structure 112, in the illustrated embodiment) are electrically coupled to a power source 130. The anodes 110 can be made of copper, or another metal or metal alloy of the desired metal layer 115 of the part. The anodes 110 can be placed in the solution tank 104. The anodes 110 can be located in the solution tank 104 during the MIP-SL process. The power source 130 can be turned on (i.e., the circuit is closed) to energize the anodes 110. An electric current can be passed through the photocurable electrolyte solution 116 from anodes 110 to the cathode 108. During the metal printing process, and using copper as an example, though it should be understood that other metals or metal alloys can be used, the anode 110 can lose two electrons under oxidation and become metal ions (in this particular case the metal ions are copper cations Cu²⁺), which dissolve in the polymer-based, photocurable electrolyte solution 116. The copper cations in the solution 116 can be reduced to metallic copper particles at the cathode 108 by gaining two electrons and accumulating on the surface of the photocured polymer structure 112 in contact with the solution 116. Stated differently, during the electrodeposition, the anodes 110 can continuously generate copper ions, and the copper ions move to the surface of the printed polymer matrix (i.e., photocured polymer structure 112) to obtain electrons and form copper particles. In various embodiments, the photocured polymer structure 112 can be moved upward and metal can accumulate on the photocured polymer structure 112 layer by layer until a final shape is formed. The time and voltage of electrodeposition can be 5 minutes and 15V, respectively. The voltage of electrodeposition can be between 10V and 100V. In some embodiments, the voltage of electrodeposition is at least 80V to ensure deposition as the conductivity of the solution 116 decreases due to loss of H2O as a result of generated heat during the EF-HMP process. Accordingly, the time and voltage of electrodeposition can be 12 minutes and 80V, respectively, in intervals of 4 minutes. Though the time and voltage of electrodeposition can vary depending on the conductivity of the solution 116 and the desired layer thickness.

The apparatus 100 can further include a control unit 132, which includes one or more controllers (e.g., processors) and one or more tangible, non-transitory memories capable of implementing digital or programmatic logic. In various embodiments, for example, the one or more controllers are one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various embodiments, the control unit 132 controls, at least various parts of, the flight of, and operation of various components of, the apparatus 100. For example, the control unit 132 can control a position of printing platform 102. In this regard, the control unit 132 can be in electronic communication with the printing platform 102. The control unit 132 can control electric current supplied to the anodes 110 and/or cathode 108. In this regard, the control unit 132 can be in electronic communication with the power source 130. For example, the control unit 132 can be configured to connect and/or disconnect the power source 130 from the circuit (i.e., the cathode 108 and the anode(s) 110). The control unit 132 can control the light source 106. In this regard, the control unit 132 can be in electronic communication with the light source 106. For example, the control unit 132 can be configured to turn on and/or turn off the light source 106.

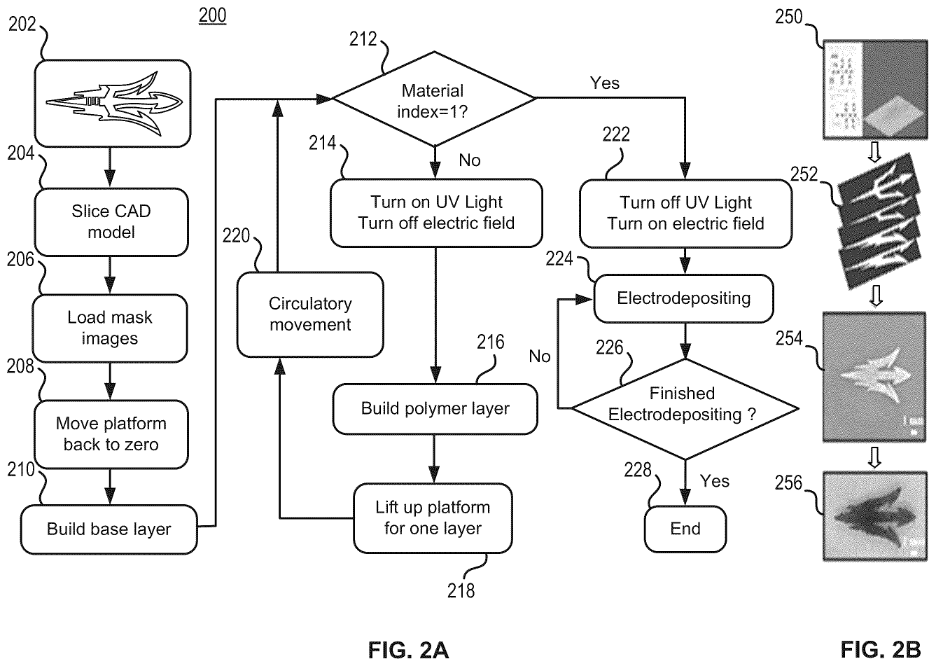

During testing, a pitchfork and a circuit were fabricated to show the print capability and accuracy of the disclosed EF-HMP process. As shown in FIG. 2A and FIG. 2B, the pitchfork was cured layer by layer on the base layer, which was designed to make the cured layer better adhere to the printing platform. The sharp edges and corners of the printed pitchfork are visible, and the width of the narrowest area is a few hundred microns. After the fabrication of polymer layers, the light source was turned off, and the electrical field was turned on for 5 mins at 15V. Using the same printing solution, a thin layer of copper grew on the surface of the last layer of the printed pitchfork. The thickness of the deposited copper was about 45 μm. With regard to the microscopic morphological distribution of the deposited copper, numerous copper particles with a size of a few microns were uniformly attached to the polymer surface. Furthermore, the EF-HMP process can be used to print a flexible circuit. For example, the conductive circuit consisting of a LED light and copper/polymer-based lines were designed and fabricated using a single step. The lower ends of the polymer lines were connected to a DC power supply (5V). When the two poles of the LED light touched the upper end of the line without the copper layer, the LED didn't light up. When the circuit line was printed with copper layer, the circuit was turned on, and the LED lighted up. Experimental results of conductive circuit show its broad prospects in the fabrication of polymer/metal devices for the applications such as sensor, antenna, and integrated circuits with complex shape accuracy.

With reference to FIG. 2A, a flow chart for a method 200 for additively manufacturing a metal-polymer composite structure is illustrated, in accordance with various embodiments. For ease of description, the method 200 is described below with reference to FIG. 1A and FIG. 1B. The method 200 of the present disclosure, however, is not limited to use of the exemplary apparatus 100 of FIG. 1A and FIG. 1B.

At block 202, a digital model 250 of a desired 3D shape is designed and/or generated, such as a CAD model. The digital model 250 can be stored in memory.

At block 204, the digital model 250 can be sliced to generate a series of mask images 252. During the slicing, the material index of each layer can also be stored in memory with the generation of the mask images 252. The layer onto which the metal is to be deposited can be marked with an identifier, such as 1 for example.

At block 206, during or after the slicing process of block 204, the mask images 252 can be loaded into a printing operation software to form a light beam with the desired 2D pattern. For example, a first layer can be formed with a light beam having a first 2D pattern and a subsequent layer can be formed with a light beam having a second 2D pattern that is different form the first 2D pattern.

At block 208, the printing platform 102 can be moved to an initial position. In order to initialize the position of the printing platform 102, the printing platform 102 can be lowered to just touch the upper surface 134 of the solution tank 104. The upper surface 134 of the solution tank 104 can be coated with a Polydimethylsiloxane (PDMS) or Polytetrafluoroethylene (PTFE) film 136 to form a horizontal flat surface in order to avoid curing uneven layers. Moreover, the film 136 can reduce the peeling force and increase the surface roughness of the photocured polymer structure 112, which can be important for a further metal deposition because the film 136 can improve the adhesion of metal particles to the photocured polymer structure 112 and the conductivity of the surface of the photocured polymer structure 112. Accordingly, in various embodiments, the printing platform 102 can be lowered to just touch the film 136.

At block 210, a base layer of the photocured polymer structure 112 is built. After setting initial position, the printing platform 102 can then be raised by a predetermined distance, such as 200 μm. In response to the printing platform 102 being raised from the upper surface 134, additional photocurable electrolyte solution 116 can fill the space between the photocured polymer structure 112 and the upper surface 134. The light source 106 can then be turned on to expose this additional photocurable electrolyte solution 116 located between the upper surface 134 and the cathode 108 to the light energy 120 which has the desired 2D pattern of the mask image corresponding to the base layer. The photocurable electrolyte solution 116 can be exposed to the light energy 120 for a predetermined exposure time. The predetermined exposure time can be between four minutes and thirty minutes in various embodiments, between eight minutes and twenty-four minutes in various embodiments, between twelve minutes and twenty minutes in various embodiments, or about sixteen minutes in various embodiments, wherein the term “about” in this regard can only mean plus or minus one minute. The base layer can help eliminate voids or intrusion into the film 136 during initialization.

At block 212, the control unit 132 checks to determine if the material index is equal to the identifier of the layer onto which the metal is to be deposited (e.g., 1). If the material index is not equal to 1, additional layers of the photocured polymer structure 112 are built and the method 200 proceeds to block 214. If the material index is equal to 1, the method 200 proceeds to block 222 for electrodeposition.

At block 214, the light source 106 is turned on. At block 214 the electric field is turned off (if it is currently on). Otherwise, the electric field remains off.

At block 216, the light source 106 remains on for the predetermined duration to build or cure another polymer layer (see layer 254) of the photocured polymer structure 112.

At block 218, and after a layer is cured, the printing platform 102 is raised by a first predetermined distance (e.g., 2 mm). The printing platform 102 can then be lowered by a second predetermined distance less than the first predetermined distance (e.g., 1.8 mm) so that a fresh uniform layer of uncured solution 116 is moved (e.g., pulled) into the gap (between the platform 102 and the interior surface 134) as the platform 102 ascends and squeezes out (e.g., is pushed out) as the platform 102 descends. The platform 102 can descend at a speed of about 0.15 mm/s. After this series of movements ceases, the light source 106 can be turned on to solidify the solution 116 inside the gap. In this manner, the resulting polymer layer can be 200 μm. Accordingly, the light source 106 can be turned off when the platform 102 is in motion (i.e., raising or lowering). In various embodiments, the light source 106 is only on when all of the components are static. Moreover, the raising and lowering of the platform 102 occurs after the old solution layer is solidified and before the new solution layer is formed.

At block 220, the process (i.e., blocks 212-218) can be repeated until a desired thickness and/or shape of the photocured polymer structure 112 (see also photocured polymer structure 256) is achieved. The process (i.e., blocks 212-218) can be repeated until the material index is equal to 1. In various embodiments, the mask images 252 can be changed at desired intervals, for example sequentially with each layer, to achieve the desired 2D pattern for each layer.

At block 222 the light source is turned off. The printing platform 102 can be moved up so that only the surface of the photocured polymer structure onto which it is desired to form a metal layer is in contact with the photocurable electrolyte solution 116. The electric field is turned on to initiate electrodeposition. During electrodeposition, the photocured polymer structure 112 itself acts as part of the cathode 108.

At block 224, and in response to the electric field being turned on, the metal (e.g., copper) is deposited onto the surface of the photocured polymer structure (e.g., a bottom surface) in contact with the photocurable electrolyte solution 116. The electric field can be turned on for a predetermined duration, for example until a desired thickness of the metal layer is achieved (e.g., between 30 μm and 50 μm). In various embodiments, for a film with a size of 8×8 mm, an electric field with a strength of 2.5 mA/mm² can be turned on for about 15 minutes in an exemplary embodiment. In various embodiments, the metal layer is deposited in intervals, such that the metal layer has sub-layers deposited in intervals, each sub-layer being between 30 μm and 50 μm in various embodiments, between 100 μm and 300 μm in various embodiments, and between 30 μm and 300 μm in various embodiments. The printed metal particles can be attached to the surface of the photocured polymer structure in the form of coarse grains with a diameter of about 2 μm while the morphology of the photocured polymer structure is much smoother.

At block 226 it is determined whether electrodeposition is finished. For example, a thickness of the metal layer can be measured and/or determined, or it can be determined whether the predetermined duration has expired. If electrodeposition is not finished, the method returns to block 224. If electrodeposition is finished, the method ends at block 228.

In the illustrated embodiment of FIG. 2B, a pitchfork is depicted printed using the aforementioned process, though any suitable 3D part can be printed using the apparatus and methods of the present disclosure.

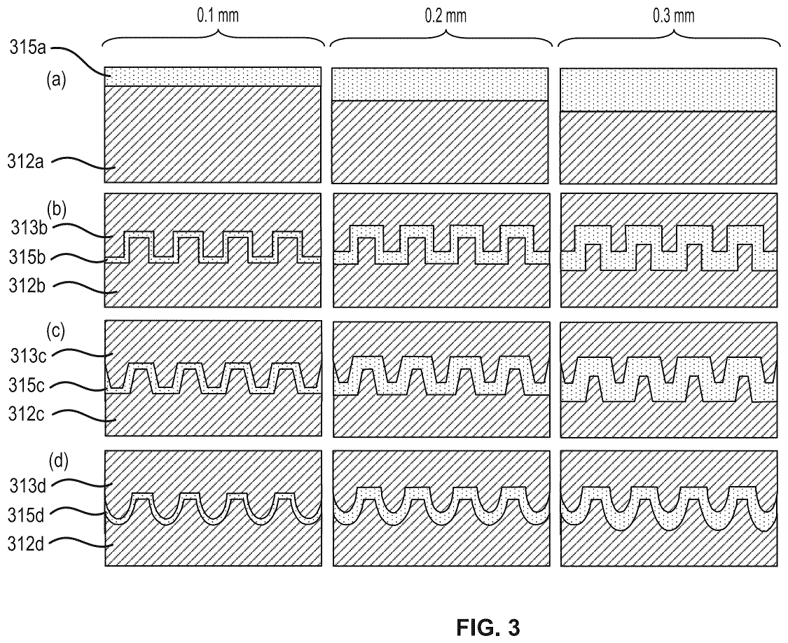

FIG. 3 illustrates four different embodiments (FIG. 3a-3d) including a linear copper metal layer 315a deposited over a photocured polymer structure 312a using an EF-HMP process of the present disclosure (FIG. 3a), a square microstructure including a copper metal layer 315b disposed between a first photocured polymer structure 312b and a second photocured polymer structure 313b using an EF-HMP process of the present disclosure (FIG. 3b), a trapezoidal microstructure including a copper metal layer 315c disposed between a first photocured polymer structure 312c and a second photocured polymer structure 313c using an EF-HMP process of the present disclosure (FIG. 3c), and a semicircular microstructure including a copper metal layer 315d disposed between a first photocured polymer structure 312d and a second photocured polymer structure 313d using an EF-HMP process of the present disclosure (FIG. 3d). Although illustrated as being sandwiched between two photocured polymer structures 312, 313, it should be understood that a square microstructure, trapezoidal microstructure, or semicircular microstructure can be formed by electrodepositing the metal layer 315 over the photocured polymer structures 312 without forming an additional photocured polymer structure 313 over the metal layer 315.

The electrical conductivity of metallic and polymer microstructures is a property that has been extensively studied for various applications in fields such as electronics, energy storage, and sensors. Modeling this property accurately is desirable to optimize the performance of metallic and polymer microstructures. In metallic microstructures, the electrical conductivity is influenced by factors such as the material properties, the microstructure geometry, and the fabrication method used. By accurately modeling these properties, one can predict the conductivity and resistivity of the material and identify any potential issues that may arise under different conditions. These simulations, when combined with physical measurement, can provide a comprehensive understanding of the material's electrical characteristics. One such example of a conductive polymer mixture is PEDOT:PSS. It is composed of two ionomers, one of which is sulfonated polystyrene and the other is a conjugated polymer based on polythiophene, known as poly(3,4-ethylene dioxythiophene) (PEDOT). These charged macromolecules form a macromolecular salt and provide conductivity to the material, even after printing. PEDOT:PSS has the highest efficiency among conductive organic materials, making it suitable for flexible and biodegradable electrical circuits.

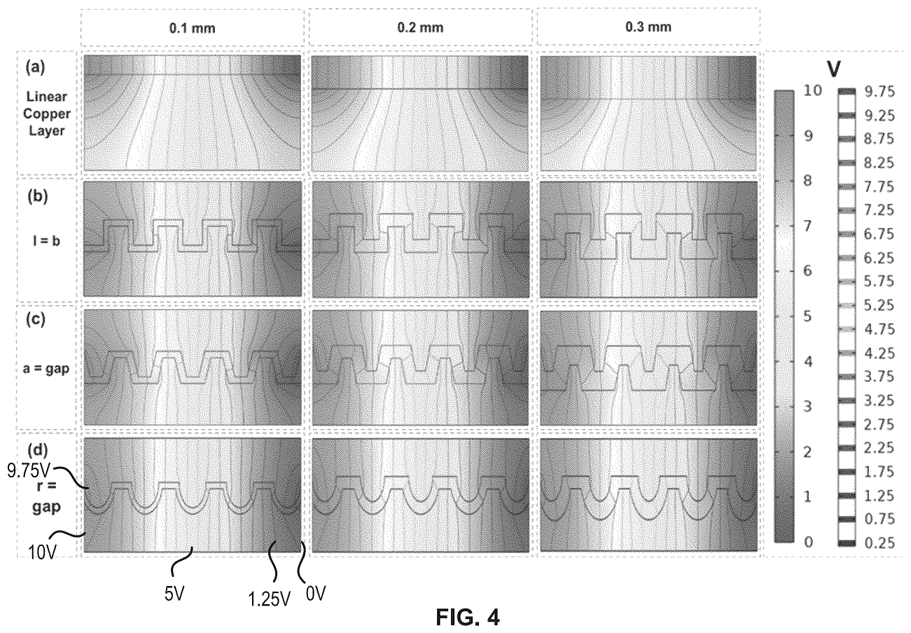

With additional reference to FIG. 4, to understand the performance of metallic deposition over microstructures for conductivity, various designs were simulated using software (e.g., COMSOL Multiphysics). The first test case (see FIG. 3a and FIG. 4a) involved simulating a uniform linear layer of copper over a conductive polymer. The top layer was made of copper, while the bottom layer consisted of a conductive polymer. A voltage of 10V was applied to the left part of the copper layer, while the right part was grounded. A simulation was performed to represent the concentration of electric potential in the geometry, while contour lines showed the level at which the potential varies in the geometry (see FIG. 4). By varying the thickness of the copper layer from 0.1 mm to 0.3 mm, the simulation was able to show how the region of high electric potential changed concerning the thickness of copper on the conductive polymer. To assess the effects of the microstructure shape on the variation of electric potential, three additional test cases were simulated. In each case, a copper layer was sandwiched between microstructures made up of conductive polymer. The microstructures used in these tests were a rectangular structure with equal length and width (FIG. 3b and FIG. 4b), a trapezoidal structure with a bottom length equal to the gap between consecutive trapezoidal structures (FIG. 3c and FIG. 4c), and a semicircular structure with a radius equal to the gap between structures (FIG. 3d and FIG. 4d). The thickness of the copper layer was varied from 0.1 mm to 0.3 mm to observe the variation of electric potential with thickness. One end of the copper layer was set to a 10V electric potential, while the other end was grounded. The dark areas at the left of each part indicated high potential near the copper boundary, while dark areas at the right of each part represented ground on the other end of the sandwiched copper layer. The contour lines showed the exact level at which the potential varied across the geometry, illustrating major changes in the copper layer region. Each design showed different variations in terms of color contour and the direction followed by the contour lines.

By predicting the conductivity and resistivity of the material, the simulation provided valuable insight into how these microstructures would perform under different conditions. The simulation of metallic and polymer microstructures is useful for optimizing their performance in a wide range of applications, including electronics, energy storage, and sensors. By accurately modeling the electrical conductivity of these materials, researchers can identify potential issues and make modifications to enhance their performance. Further, a digital multimeter was used to measure the resistance of 3D-printed parts.

The electrical resistance of an object is a measure of its resistance to the flow of electrical current. Polyethylene glycol diacrylate (PEGDA) without any conductive fillers is an inductor, and to make it a conductor, a pellet based on PEDOT:PSS was added as a conductive organic material during testing. To determine the electrical resistance of various printed samples, a multimeter was used for physical measurement. During testing, and for a thin film printed using a photocurable electrolyte solution of the present disclosure, resistance was measured by placing two probes at separate ends of the thin film. The resistance was approximately 298 k Ω when the film was dry, and the resistance dropped to 135 k Ω when it was wet. In the case of a 3D-printed cube, the resistance was around 128 k Ω when it was dry, and the resistance dropped down to 74.5 k Ω when it was wet. After metal deposition, cubes having a metal layer sandwiched between two polymer layers were tested for resistance between the gaps where the copper layer was deposited. The cube with a rectangular microstructure had a resistance of 25 k Ω, whereas the cube with a trapezoidal microstructure had a resistance of 18 k Ω. The cube with a circular microstructure had the lowest resistance of all, which was 12 k Ω. Accordingly, the circular microstructures had the best deposition results, which resulted in lower resistance compared to the other microstructures. However, due to the non-uniform deposition of copper and the high resistance of the 3D-printed cubes, the overall resistance remained high even after deposition.

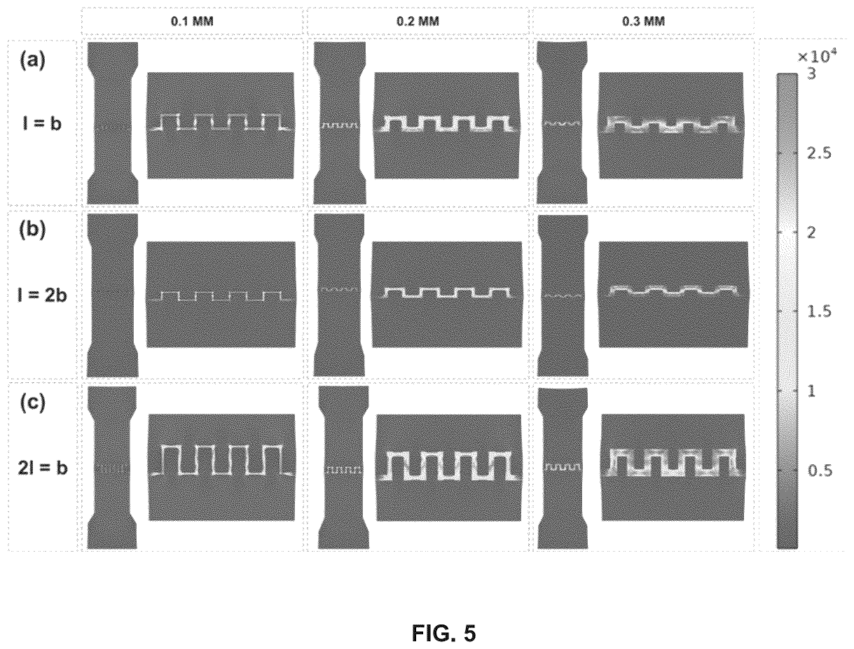

With reference now to FIG. 5, tensile testing (a destructive procedure employed to determine the tensile strength, yield strength, and ductility of a test specimen, usually made of plastic or composite materials) was simulated. The test involves measuring the amount of force required to break the specimen and the degree to which it stretches or elongates before breaking. In complex loading scenarios, the von Mises stress is used to predict the yielding of materials, based on the results of uniaxial tensile tests. The von Mises stress satisfies the criterion that two stress states with equal distortion energy have an equal von Mises stress. The mechanical performance of metallic and polymer microstructures can be modeled using software (e.g., COMSOL Multiphysics software), which includes a CAD designer for creating models. A tensile test bar was created in compliance with ASTM standards to evaluate the bonding between a copper layer and polymer parts. The copper layer was placed between the polymer components, and the simulation aimed to measure the levels of von Mises stress on the interface under different design configurations. Various simulations were conducted, each featuring a unique microstructure design and a different thickness of copper layer sandwiched between the polymer components. Simulations were performed using copper layers of 0.1 mm, 0.2 mm, and 0.3 mm in thickness. The lower end of the specimen was fixed in place, while a perpendicular force of ION was applied at the upper boundary.

The initial test involved using rectangular microstructures to sandwich a copper layer, as shown in FIG. 5. Increasing the thickness of the copper layer led to a reduction in von Mises stress. The stress levels at the far ends of the copper layer were found to be lower than those in the middle section. The first simulation maintained an equal length and width of the rectangular microstructure (FIG. 5a), which resulted in high stress levels. However, increasing the thickness of the copper layer led to a reduction in stress.

In the second simulation, the width of the microstructure was twice the length (FIG. 5b). Similar to the first simulation, increasing the thickness of the copper layer resulted in lower stress levels. The third simulation had a length twice the width of the microstructure (FIG. 5c). This simulation produced the best result, with significantly lower stress levels than the other simulations, even with a copper layer thickness of only 0.1 mm.

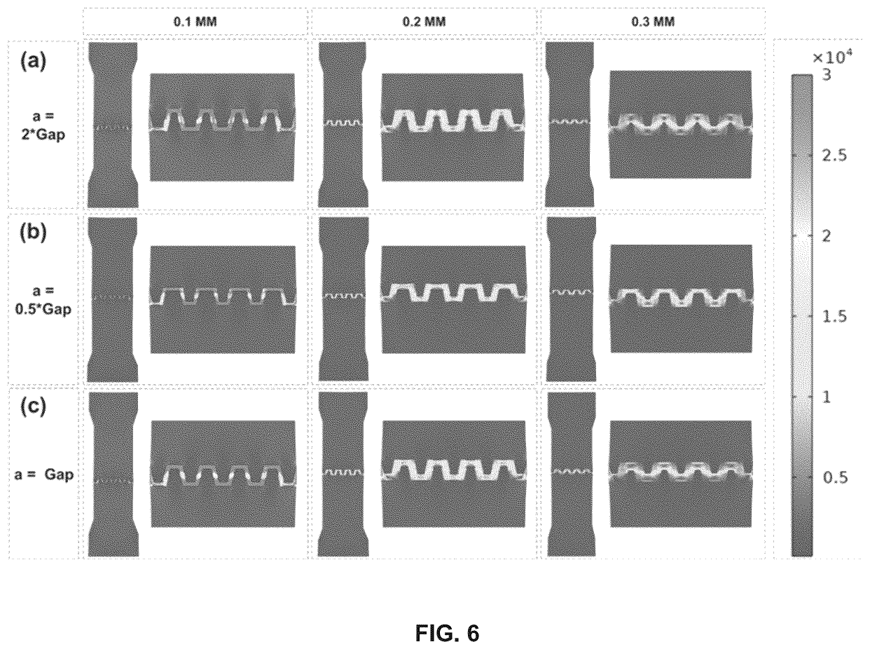

With reference now to FIG. 6, a copper layer was placed between trapezoidal microstructures in the second test. Von Mises stress was considerably reduced as the copper layer's thickness was increased. Contrary to the outcomes of the earlier simulation described with respect to FIG. 5, the stress levels at the far ends of the copper layer were noticeably higher than those in the intermediate part. In the initial simulation, trapezoidal microstructures were used, with the bottom length being double the distance between each microstructure (FIG. 6A). This caused the copper and polymer interaction to experience high amounts of stress. Yet, the stress decreased as the copper layer's thickness increased. In the second simulation, the microstructure's bottom length was half that of the microstructures' distance from one another (FIG. 6b). The copper layer's thickness was increased, like in the first simulation, and this resulted in reduced stress levels. The bottom length of the trapezoidal microstructure was equal to the space between microstructures in the third simulation (FIG. 6c). Remarkably, no matter the size of the microstructures used in the simulations, the results were identical, or nearly identical; the only difference was that the stress decreased as the copper layer's thickness increased.

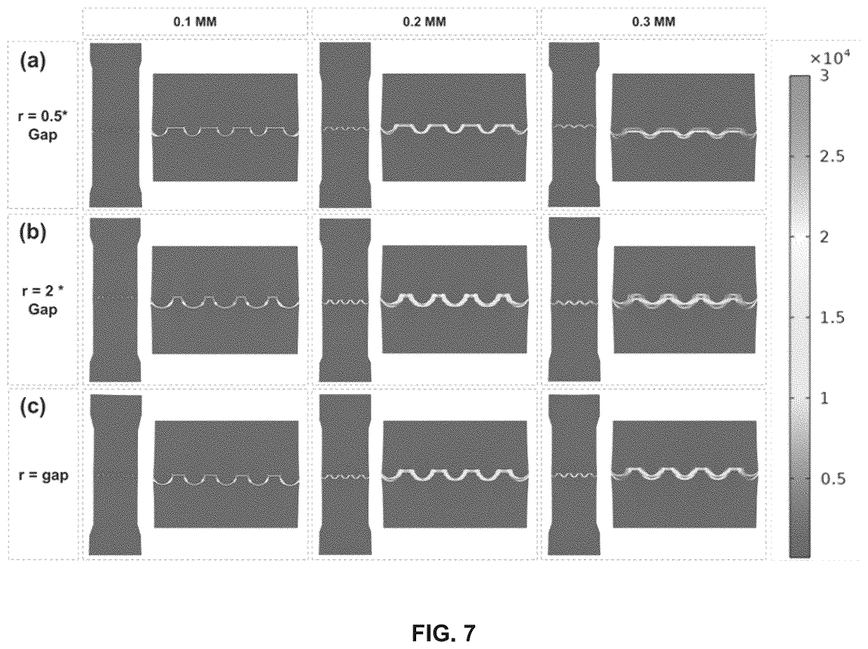

With reference now to FIG. 7, the third test used semi-circular microstructures and sandwiched copper between polymer structures. The results of the simulation were equivalent to those of the earlier experiments. The copper layer's extreme ends saw significantly less stress than its center, in contrast to the trapezoidal models. In the original simulation, semicircle microstructures with a radius equal to half their distance apart were used (FIG. 7a). High-stress levels were a result of the copper-polymer contact. Yet, the tension was reduced when the copper layer's thickness was increased. In the second simulation, the microstructure's radius was twice as long as the distance between them (FIG. 7b). Like the first simulation, the stress levels fell when the copper layer's thickness was increased. The third simulation had a semi-circular microstructure with a radius equal to the distance between them (FIG. 7c). Intriguingly, semi-circular microstructures in all simulations yielded the same outcomes regardless of the dimensions of the microstructures, with the sole difference being a decrease in stress with increasing copper layer thickness.

Accordingly, a metal-polymer composite structure having a microstructure geometry (e.g., linear, square, rectangular, trapezoidal, or semicircular) as described with respect to any of FIG. 3 through FIG. 7 can be manufactured using an EF-HMP process of the present disclosure.

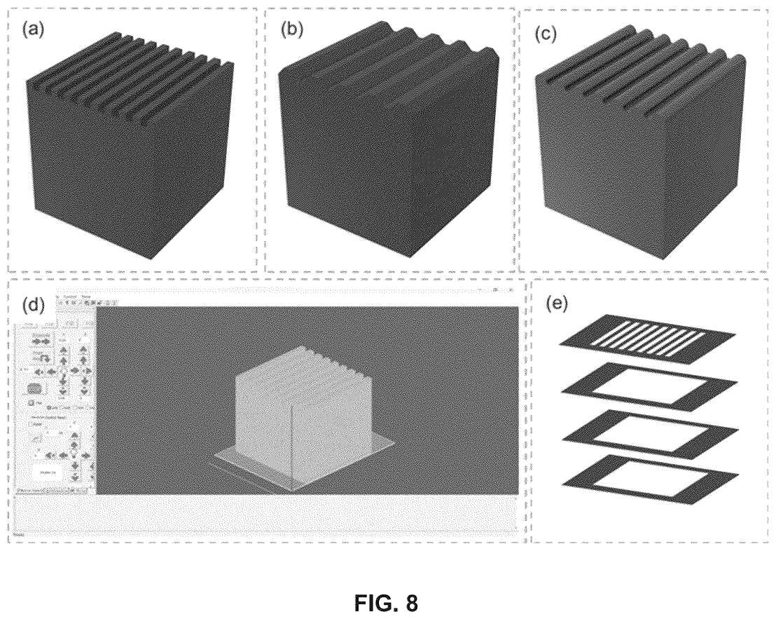

With reference now to FIG. 8, to study the deposition of copper onto the structures made of photocurable electrolyte solution, microstructures were introduced to study the effect of various shapes on deposition. For example, FIG. 8a shows a photocured structure having square microstructures, FIG. 8b shows a photocured structure having trapezoidal microstructures, and FIG. 8c shows a photocured structure having semicircular microstructures. When comparing the size ratio between the projected CAD model (see FIG. 8d) and the actual size of the printed item, the original CAD model is accurately updated in terms of dimensions and turned into an STL file. The Slicer Software (see FIG. 8d) is then used to slice this model horizontally. As a result, the set of sliced photos utilized as masked images (see FIG. 8e) is utilized for printing. The number of photos obtained can depend on the CAD model's curing depth and the depth at which it was sliced. The CAD model's size can alter the actual size of the printing structure. The structure is printed using these photos, which are kept in a folder and printed one after the other. After being divided into slices for VPP 3D printing, the pictures are projected one at a time from the projector onto the bottom surface of the solution tank. A collection of sliced photos (see FIG. 8e) that are saved in a folder are used by the application that projects these masked images onto the bottom surface of the solution tank. The solution tank can be anchored in every direction to avoid any movement. A flat guiding tool (e.g., the printing platform) can be set such that there is some resin between its lowest point and the tank's bottom surface so that the UV lights can cure a layer and print it on the flat tool. The programming software regulates the exposure time, the number of layers to print, the travel distance of the flat tool, the layer thickness, and the projected images. As a result, after the initial picture is projected into the photopolymer resin, the first layer is printed on the flat tool's bottom surface. The flat tool is then elevated to form a new layer based on the set layer thickness and lowered in a regulated motion to allow extra resin in between the subsequent layers. A structure is then printed after several iterations. The UV projector emits images that are illuminated by bright light. As a result, the photopolymer might over-cure. So, the intensity of the UV projector can be kept at only a fraction of the highest intensity (e.g., 30% intensity).

The study was conducted for three different microstructures and each cad model was designed to its specifications. The structures that were selected to be made at the bottom of the cube were a rectangular shape (FIG. 8a), a trapezium (FIG. 8b), and a semi-circle (FIG. 8c). For the rectangular shape, the cad model was sliced for 100 microns per layer whereas for the trapezium shape at the bottom, the cad model was sliced for 50 microns per layer to achieve the proper shape of the microstructure and for the semi-circle shape at the bottom the cad was sliced for 35 microns per layer. For all the cubes the total height was kept at 0.5 mm whereas the microstructure was 400 microns in height. The final printed cube was 6.1 mm in length and 6.4 mm in breadth with the microstructures printed along the length.

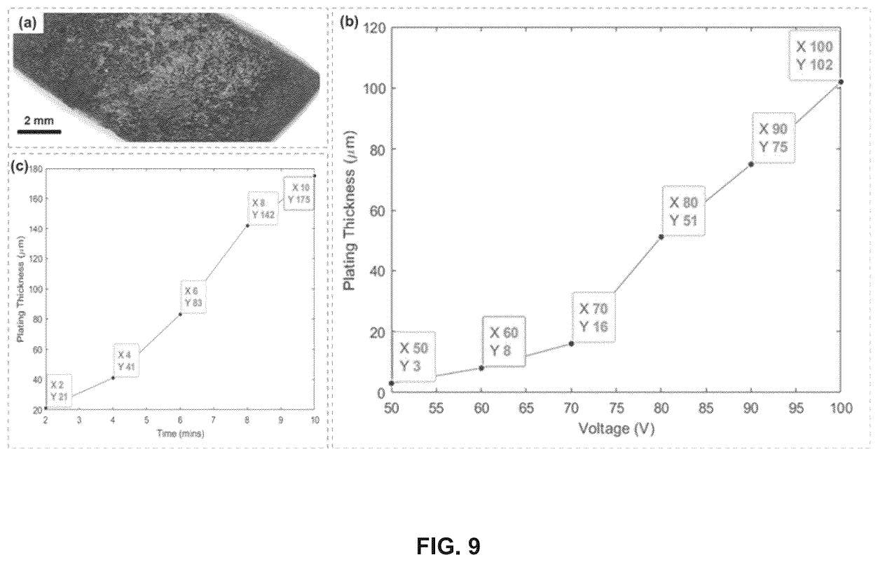

With reference now to FIG. 9, further investigation was conducted on the formation of metallic structures after investigating the ability of the printing electrolyte solution to cure. To investigate the viability and efficiency of the metal deposition under the electrical field using the photocurable electrolyte solution, the fabrication performance of metallic structures using EF-HMP was quantitatively evaluated by calculating the thickness of the deposition. Electrical field-assisted metal deposition on the photocurable electrolyte solution shows a high correlation between deposition thickness, electrical charge, and deposition time. Studies were conducted for various voltages and times on a thin film to monitor the deposition of copper (see FIG. 9a). To investigate the quality of metallic structures printed by the EF-HMP technique, a physics-assisted simulation was carried out. A range of voltages between 50V and 100V was employed in the studies to determine the link between deposition thickness and various voltages for a set time of 5 mins. When a 50V voltage is used, the copper deposition thickness after 5 minutes can reach 3 μm. To constantly start the electron, transfer necessary for electrical field-assisted metal deposition to produce a thicker coating, there was not enough potential difference. Yet, the thickness of copper that was deposited increased as the applied voltage crossed a particular threshold. For instance, when the deposition duration was 5 minutes, the copper deposition thickness increased from 8 μm at 60V to 51 μm at 80V (see FIG. 9b). Yet, too-high a voltage can have adverse consequences that electrolyze the water in the solution, and this response is consequential. This is because the copper cations Cu²⁺ movement speed in a high-viscosity solution is constrained. The cured component will also progressively start to lose water and have its conductivity reduced by the heat produced during the electrical field-assisted metal deposition process, which prevents it from supporting metal deposition. The thickness of copper at various depositing times under 80V was experimented with in terms of deposition time. In 2 minutes, the thickness was 21 μm, and at 10 minutes, it was 175 μm (see FIG. 9c). After 10 minutes, however, the thickness remained constant, and the produced copper particles were dissolved in the printing solution close to the deposition area. This is due to the pre-deposited copper coating on the hardened polymer component making it difficult for the newly deposited copper particles to adhere.

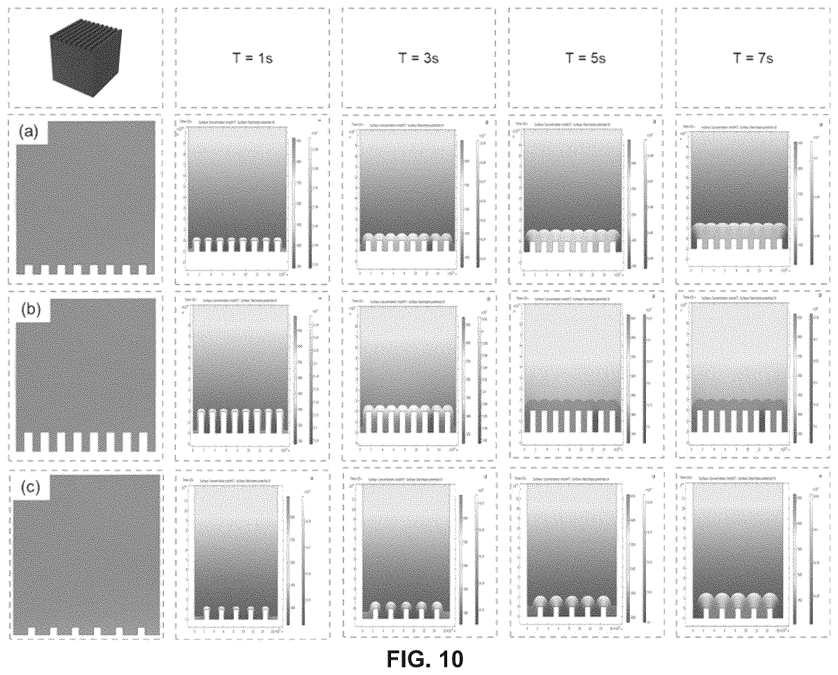

With reference now to FIG. 10, several designs, including rectangular, trapezoidal, and semicircular microstructure forms, were simulated. Each simulation was run many times for time intervals ranging from 1 to 9 seconds at a 2-second interval. The CAD designer software was used to build a total of 9 different designs that were then simulated for electro-deposition. According to the simulation results, a thin, homogeneous layer of copper particles progressively forms on the pre-cured polymer-based component. This layer is exposed to an electric field. The thickness of the plating layer gradually increases over time, according to the modeling of the developing process of the metallic structures on the flat surface plating. It was assessed how well metallic structures with complicated 3D shapes, such as semicircular, trapezoidal, and rectangular microstructures, could be formed. The dimension of the domain was set as 2*3 mm for all the simulations and the microstructures were uniformly distributed in the domain. Due to the uneven coating thickness, it was discovered that the top surface of the microstructure was thicker than the others. The distribution of the electric potential will be directly impacted by the unevenness formed by the metallic structures on the microstructure, which will further reinforce the growth's non-uniformity. As a result, it is desirable to modify the deposition time during the printing of the metal layer to manage the uneven growth of the metallic structures. A large shift in the concentration of copper cations Cu²⁺ in the solution close to the deposition area is also indicated by the simulation findings, which is consistent with the number of copper particles deposited on the surface. The simulation results were used to understand the deposition of copper onto microstructures.

In the first test case, three rectangular microstructure designs were created, all with the same overall domain but varying in length and width. In the first case, the length and width of the microstructure were equal (FIG. 10a). As time progressed, the thickness of the deposited copper increased, starting at the walls of the microstructure. At t=1s, uneven deposition of copper was observed on the microstructure walls. By t=7s, the microstructures were completely covered with deposited copper, with higher concentrations of copper at the center and lower concentrations at the far ends. In the next case, the length of the microstructure was twice that of the width (FIG. 10b), and in the third case, the width was twice the length (FIG. 10c). The deposition of copper particles over time followed the same trend for all three designs. However, the only notable difference was the formation of bumps and the convexity of the same due to the inability of copper ions to adhere to pre-deposited copper effectively.

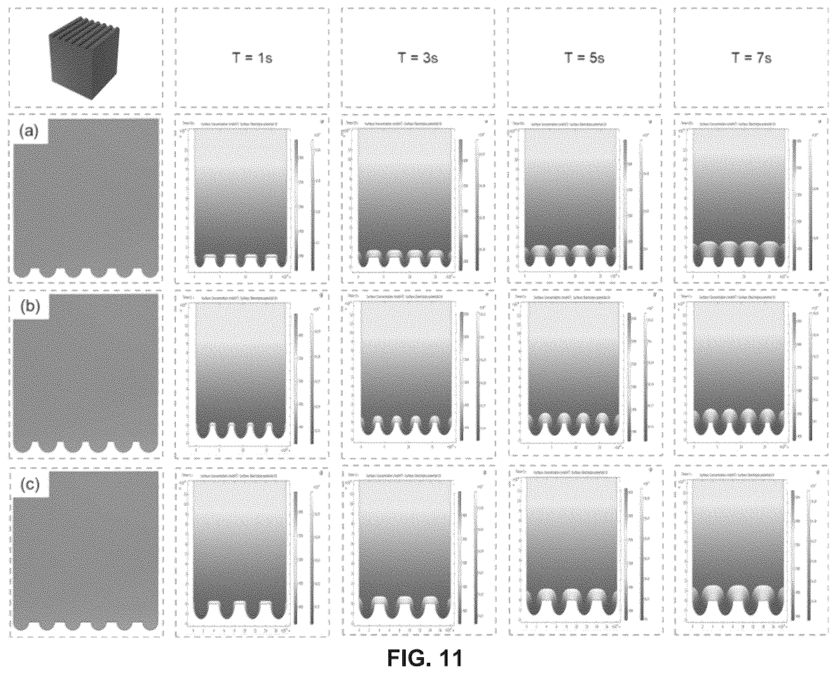

With reference now to FIG. 11, in the second test case, three semi-circular microstructure designs were created, varying in the radius of the semi-circle compared to the gap. For the first design, the radius of the semi-circle was half of the gap (FIG. 11a), while in the second, it was twice the gap (FIG. 11b). In the third design, the radius of the semi-circle was equal to the gap (FIG. 11c). Like the first test case, as time progressed, the thickness of the deposited copper increased, starting at the walls of the microstructure. Even deposition of copper was observed on the microstructure walls at t=1s for all three designs. By t=7s, the microstructures were completely covered with deposited copper, with higher concentrations of copper at the top and lower concentrations near the microstructures. The deposition of copper particles over time followed the same trend for all three designs, but there was a notable difference in the depth of the troughs at t=7s. In particular, the troughs in FIG. 11C were much deeper compared to the other test cases.

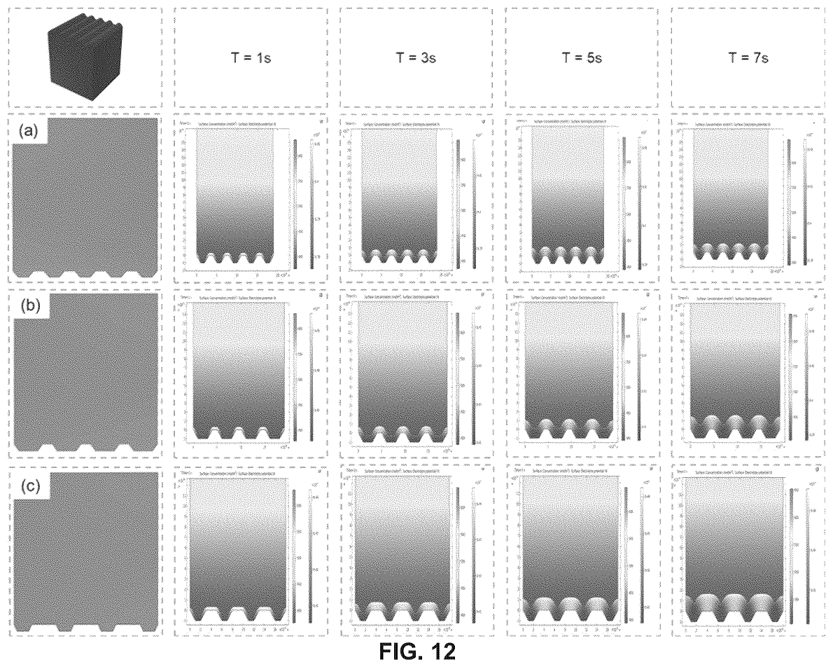

With reference now to FIG. 12, in the third test case, three trapezium-like microstructure designs were created, varying in the bottom length of the trapezium compared to the gap. In the first simulation, the bottom length of the trapezium was equal to the gap (FIG. 12a), while in the second simulation, it was twice the gap (FIG. 12b). Third, the bottom length of the trapezium was half the gap (FIG. 12c). Like the previous test cases, the thickness of the deposited copper increased as time progressed, starting at the microstructure walls. Even deposition of copper was observed on the microstructure walls at t=1s for all three designs, and by t=7s, the microstructures were completely covered with deposited copper, with higher concentrations at the top and lower concentrations near the microstructures. The deposition of copper particles over time followed the same trend for all three designs, but the only notable difference was the formation of bumps and the convexity of the microstructures. However, the number of bumps in this test case was significantly less compared to the first test case.

The experiments conducted on the photocurable electrolyte solution, aided by an electrical field, revealed a strong correlation between the thickness of the deposition, the electrical charge, and the deposition time. To study the relationship between deposition thickness and different voltages, the experiments used a range of voltages from 50V to 100V. The results showed that there was not enough potential difference to initiate the electron transfer necessary for thicker coating at a constant rate. However, the thickness of the copper deposition significantly increased as the applied voltage crossed a certain threshold. After conducting various tests on a thin film, the deposition voltage was set at 80V. The 3D-printed cubes, measuring 5 mm in height, were printed using the photocurable electrolyte resin. After printing, the cubes were immersed in copper sulfate solution to keep them wet as the electrical conductivity of the material decreased significantly after drying. Each test case involved electroplating the cube for 12 minutes at 80V in intervals of 4 minutes. This was desirable as the heat generated during the electrical field-assisted metal deposition process gradually made the cured part and the solution loses water, thus reducing their conductivity and preventing further deposition.

For the first specimen with rectangular microstructure, deposition occurred only between the microstructures, as the top part was smooth and did not allow copper particles to adhere. Whereas the copper deposition for the second specimen with trapezoidal microstructure was better due to the reduction of layer breadth during the printing process, which resulted in a rougher surface and better deposition results.

The copper deposition on the third specimen with semi-circular microstructures was the best of the three designs. This was due to the greater reduction of layer breadth during the printing process, resulting in a rougher surface and better deposition results. In all three cases, the deposition occurred between the gaps of the microstructures, and the simulation results showed that the best deposition results were obtained with the semi-circular pattern.

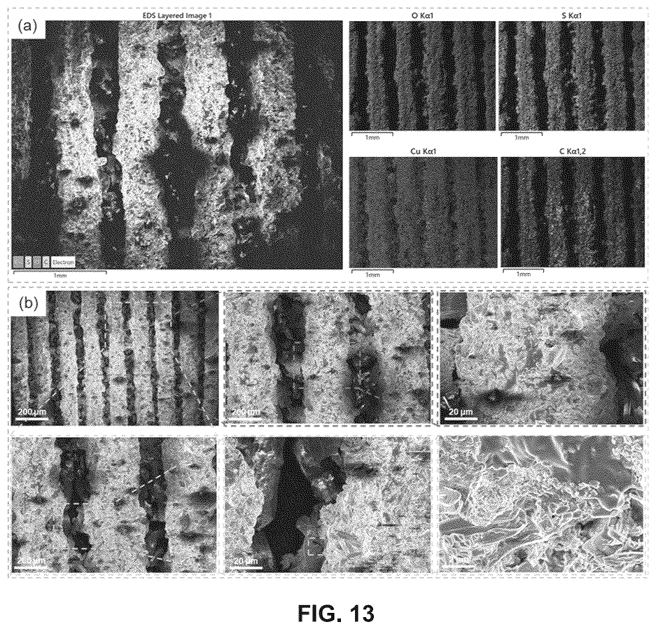

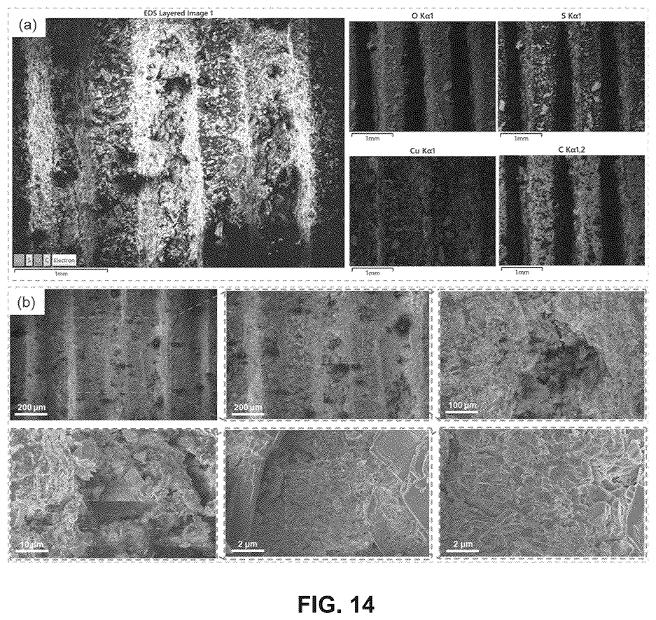

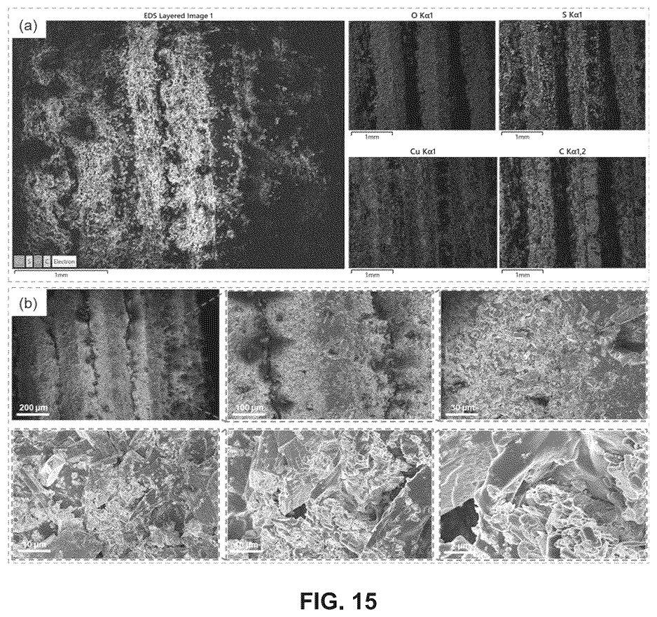

With reference now to FIG. 13, FIG. 14, and FIG. 15, an effective imaging method used to examine the surface appearance and structure of various samples is scanning electron microscopy (SEM). It functions by scanning a sample's surface with an electron beam to provide high-resolution pictures of the sample's topography. In conjunction with SEM, the analytical method known as energy dispersive X-ray spectroscopy (EDS) can reveal a sample's constituent makeup. As an electron beam interacts with the atoms in the sample, distinctive X-rays are created that can be detected by EDS. The elemental makeup of the sample is then determined by analyzing these X-rays. The procedure of using both SEM and EDS to examine the surface morphology and components of a part after copper deposition was carried out. These two methods were used to compile a thorough examination of the part's surface characteristics and chemical composition.

For the first test, a cube with rectangular microstructures (see FIG. 3a and FIG. 13) was used, and the upper part of these microstructures were the focus of the microscopy and spectroscopy. With a focus on the region of copper deposition, this method enabled a targeted study of the sample's surface characteristics and chemical composition. The upper surface of the cube showed the presence of copper, sulfur, oxygen, and carbon, per the EDS findings (see FIG. 13a). Unevenness and cavities in the structure were discovered through additional SEM investigation of the surface morphology of the rectangular microstructures (see FIG. 13b). Zooming in revealed the crystal structures of the deposited copper. The gap region was less obvious in the EDS data than the upper section of the microstructures because of the consistency and depth of the gaps.

In the second test, SEM and EDS were used to assess trapezoidal microstructures (see FIG. 3b and FIG. 14). The analysis's focus on the copper-deposition region made it possible to examine the sample's surface characteristics and chemical make-up with precision. The microstructures' upper surfaces were found to include copper, sulfur, oxygen, and carbon, with more copper being present than in the first case, according to the EDS data (see FIG. 14a). A deeper SEM investigation of the surface morphology of the trapezoidal microstructures revealed less voids and irregularities, which can be attributed to the sample's printing process's reduced layer thickness (see FIG. 14b). Zooming in revealed a denser network of crystal formations. Contrary to the first instance, the distance between succeeding gaps was greater, vividly highlighting the gap section in both the EDS and SEM data.

The third test employed semi-circular microstructures (see FIG. 3d and FIG. 15) for the same evaluation procedure. The EDS results, which showed the deposition of all other substances as well as a higher amount of copper between the gaps, further validated this test's highest deposition performance among the three examples (see FIG. 15a). Due to the utilization of the thinnest layer thickness during printing, SEM inspection of the surface morphology of the microstructures revealed nearly no voids and a better packed structure (see FIG. 15b). In contrast to the other cases, the surface also showed a richer crystalline structure, which was even more obvious when zoomed in.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of embodiments encompassed by this disclosure. The scope of the claimed matter in the disclosure is accordingly to be limited by nothing other than the appended claims, in which reference to an element in the singular is not intended to mean “one and only one” unless explicitly so stated, but rather “one or more.”

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and D” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. An additive manufacturing method for a metal-polymer composite structure, comprising:
preparing a photocurable electrolyte solution by mixing a photocurable liquid resin with a conductive nanofiller, a metal salt solution, a photo initiator, and deionized water;
initiating photopolymerization of the photocurable liquid resin to form a photocured polymer matrix by directing a projection of ultraviolet light energy from a light source onto the photocurable electrolyte solution; and
depositing a metal structure onto the photocured polymer matrix.

2. The additive manufacturing method of claim 1, wherein the photopolymerization includes:
crosslinking of a polymer chain; and
enclosing a metal salt of the metal salt solution and the conductive nanofiller during crosslinking.

3. The additive manufacturing method of claim 2, wherein the photopolymerization further includes:
switching off the light source;
raising a printing platform by a first predetermined distance;
moving uncured photocurable electrolyte solution to between the printing platform and an interior surface of a solution tank;
lowering the printing platform by a second predetermined distance;
moving a first portion of the uncured photocurable electrolyte solution from between the printing platform and the interior surface of the solution tank;
switching on the light source; and
solidifying a second portion of the uncured photocurable electrolyte solution that remains between the printing platform and the interior surface of the solution tank.

4. The additive manufacturing method of claim 2, wherein the depositing includes:
switching off the light source; and
activating an electrical field.

5. The additive manufacturing method of claim 4, wherein the activating further includes generating metal ions that move to a surface of the photocured polymer matrix, wherein the metal ions form metal particles along the surface of the photocured polymer matrix.

6. The additive manufacturing method of claim 5, wherein the depositing further includes moving the photocured polymer matrix from a first position wherein the photocured polymer matrix is at least partially submerged in the photocurable electrolyte solution to a second position wherein only a portion of the photocured polymer matrix is in contact with the photocurable electrolyte solution.

7. The additive manufacturing method of claim 6, wherein the preparing, initiating, and depositing occur at room temperature.

8. The additive manufacturing method of claim 6, wherein the electric field is generated using at least one anode located in the photocurable electrolyte solution, and the photocured polymer matrix acts as a cathode to generate the electric field.

9. The additive manufacturing method of claim 8, wherein the photocured polymer matrix includes a plurality of semicircular microstructures, and the metal structure is deposited over the plurality of semicircular microstructures.

10. An additive manufacturing system for printing a metal-polymer composite structure comprising:
a solution tank configured to contain a photocurable electrolyte solution and having a refractive surface;
a printing platform moveable with respect to the solution tank;
a light source configured to project an ultraviolet light energy through the refractive surface and into the photocurable electrolyte solution;
a cathode mounted to the printing platform; and
an anode configured to be located in the solution tank.

11. The additive manufacturing system of claim 10, further comprising a film disposed on the refractive surface, the film including at least one of a polydimethylsiloxane or a polytetrafluoroethylene.

12. The additive manufacturing system of claim 10, further comprising a power source configured to generate an electric field through the photocurable electrolyte solution using the cathode and the anode.

13. The additive manufacturing system of claim 12, further comprising a control unit in electronic communication with the power source.

14. The additive manufacturing system of claim 10, wherein the light source is a digital micromirror device projector.

15. The additive manufacturing system of claim 10, further comprising the photocurable electrolyte solution including a photocurable liquid resin, a conductive nanofiller, a metal salt solution, a photo initiator, and deionized water.

16. The additive manufacturing system of claim 15, wherein the photocurable electrolyte solution includes between 30 wt % and 35 wt % of the photocurable resin, between 1 wt % and 3 wt % of the photo initiator, between 1 wt % and 3 wt % of the conductive nanofiller, between 30 wt % and 40 wt % of the metal salt solution, and a remainder wt % of the deionized water.

17. The additive manufacturing system of claim 15, wherein the photocurable electrolyte solution includes between 32.5 wt % of the photocurable resin, 2 wt % of the photo initiator, 2 wt % of the conductive nanofiller, 35 wt % of the metal salt solution, and 28.5 wt % of the deionized water.

18. An additive manufacturing method for controlling deposition of a metallic structure onto a polymer matrix, comprising:
turning on a light source to project a light energy into a photocurable electrolyte solution;
forming a photocured polymer matrix with the light energy and the photocurable electrolyte solution;
moving a printing platform away from the light source a predetermined distance;
determining whether a material index is equal to an identifier of a layer onto which a metal is to be deposited;
in response to the material index being equal to the identifier, connecting a power source to a cathode and an anode to generate an electric field through the photocurable electrolyte solution; and
depositing the metal onto a surface of the photocured polymer matrix that is in contact with the photocurable electrolyte solution.

19. The additive manufacturing method of claim 18, further comprising:
slicing a digital model to generate a series of mask images;
storing a material index of each layer of the photocured polymer matrix in memory, wherein a layer onto which the metal is to be deposited is marked with the identifier;
loading the series of mask images to a printing operation software to form a light beam with a desired 2D pattern using the light energy; and
moving the printing platform to an initial position.

20. The additive manufacturing method of claim 18, further comprising:
raising the printing platform by a first predetermined distance; and
lowering the printing platform by a second predetermined distance, less than the first predetermined distance, so that a new layer of material is formed under pressure.
